(19) United States
(12) Patent Application Publication
(10) Pub. No.: US 2008/0091587 A1
(43) Pub. Date: Apr. 17, 2008

(54) System and method for pre-emptive auctioning

(76) Inventor: Cedric G. DeLaCruz, (US)

Correspondence Address: Cedric G. DeLaCruz, 24 Woodrow Street, West Hartford, CT, 06107, US

(21) Appl. No.: 11/985,929

(22) Filed: Nov. 19, 2007

Related U.S. Application Data
(63) Continuation-in-part of application No. 10/410,559, filed on Apr. 9, 2003.

(51) Int. Cl. G06Q 30/00; G06F 17/30

(52) U.S. Cl. 705/37

(57) ABSTRACT

The present invention is a system and method for conducting advance selling of items not yet for sale including identifying desirable items not currently for sale to put up for advance auction, monitoring the item state and/or condition during the advance auction sale and conducting the advance auction.

This application is a continuation in part of United States Patent Application publication number 20040205015, Ser. No. 10/410559, filed Apr. 9, 2003.

### BACKGROUND

Auction services/sites provide a very valuable and very popular service for both sellers and buyers. However, auctions and particularly on-line auctions suffer from a number of problems related to variety of item selection and the timing and duration during which these auctions are offered.

For example, auctions are typically limited in the amount of selection available to buyers since these auctions only cover a very limited set of currently available items up for sale within a short period of time from a few hours to generally a one to ten day period. Thus, the buyer has a very limited set of items to choose from since these auctions only have items which are actually for sale within any several day period. Currently, if a seller or owner wishes to sell their item, it must be done within a short finite period of time and thus auctions only reflect items which are immediately ready for transfer or sale within typically a less than one or two week period.

Furthermore, potential buyers have very limited time and advance notice to plan for acquisition of the item and to accumulate funds for the auction since they must close, e.g. provide payment and take possession, typically in hours or days after the initial one to ten day auction period. This is very problematic, for instance, with respect to expensive or cumbersome items like cars, boats, motorcycles, houses, apartments, etc. where the planning for acquisition of such items as well as the accumulation of funds for such an item may realistically take a lot longer. Thus in the current state of auction, all buyers must both find their desired item and bid and close on the auction within only a week or two.

Accordingly, an improved auction system and method is needed to resolve these prior art shortcomings.

### SUMMARY OF THE INVENTION

The present invention is related to a system for conducting an advance auction for an item not yet currently available. Items are selected based on their likelihood that an original owner or possessor will transfer the item at a later predictable time period.

The present invention is also a method for conducting an on-line auction for an item available for sale auction at a later date, the method comprising: identifying one or more items that will likely be up for sale at a later time; providing a advance auction for the one or more items not yet for sale; capturing information during the advance auction about the one or more items; and scheduling the one or more items for auction.

The present invention is also a method of providing anticipatory online auctions comprising, identifying likely candidate items which are not currently up for sale but are likely to be up for sale at a definable time period and conducting an auction for such items.

### FIGURES

FIG. 1 illustrates an exemplary system of the present invention.

FIG. 2 illustrates another exemplary method of the present invention.

FIG. 3 illustrates another exemplary method of the present invention.

FIG. 4 illustrates another exemplary method of the present invention.

FIG. 5 illustrates another exemplary method of the present invention.

### DETAILED DESCRIPTION

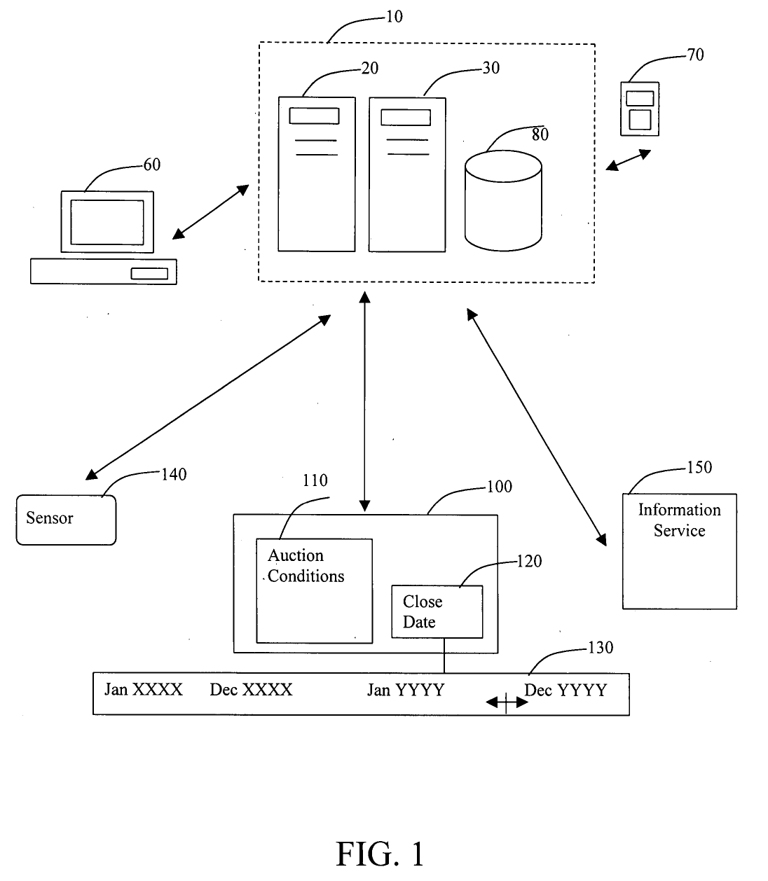

Referring to FIG. 1, the present invention relates to an advance auction system 10 which includes at least one computer network server 20, 30 for administering, conducting and maintaining one or more advance item auctions. In the present invention, items not yet available for sale are identified as being likely to be available for sale at some likely future date and an auction for the item is started even before the item is actually available for sale or even before the current owner knows they will be selling or transferring the item.

In the present invention, network server or controller 20, 30 may be configured in many different ways. For example, network server may be a conventional standalone server computer or alternatively, the function of server may be distributed across multiple computing systems and architectures. Although two servers are shown, it is contemplated that the present invention may include one or more servers.

As shown in FIG. 1, the present invention connects a plurality of sellers and buyers 60, 70 via a network server or central controller. In the present invention, the sellers and buyers can be any entity, individual, company, group or other organization. For example, exemplary sellers may be banks, lessors, landlords, real estate brokers, vehicle dealers, rental stores, commercial entities, individual people and other entities and groups. In the present invention, advance auction items are sold to one or more buyers via an advance online auction. The buyers and sellers are connected to servers 20, 30 via a communication network such as an Internet connection using a public switched phone network, such as those provided by a local or regional telephone operating company or other connection may also be provided by dedicated data lines, coaxial, fiber, cellular, Personal Communication Systems (“PCS”), microwave, or satellite networks.

Referring still to FIG. 1, servers 20, 30 provide one or more advance, anticipatory or pre-emptive auctions 100 which include one or more auction conditions 110 and a predicted auction close date 120. Auction conditions may include a description about the item, start date, condition updates, etc. Predicted close date 120 may be fixed or may be variable within a range of dates as shown in 130. Advance auction 100 may also be supplemented by one or more sensors 140 and one or more information services 150 which can potentially affect the auction parameters or conditions 110 and anticipated close dates 120.

In one example, the network server may also be configured in a distributed architecture, wherein databases and processors are housed in separate units or locations. Network server includes at least one controller or central processing unit (CPU), at least one communication port, at least one random access memory (RAM), at least one read-only memory (ROM) and one or more databases or data storage devices 80.

Data storage device may include hard disk magnetic or optical storage units, as well as CD-ROM drives or flash memory. Data storage device contains databases used in processing transactions in accordance with the present invention, including for example, an advance item database, a buyer database, a seller database, a transactions database and a condition database. In one embodiment, database software creates and manages these databases. Calculation algorithms for both auction transaction functions and seller identification may be stored in storage device and executed by the CPU.

Buyer database maintains data on buyers with fields such as name, address, credit card number, phone number, ID number, social security number, electronic mail address, credit history, past system usage, public/private key information, etc. This information is obtained when the buyer first registers with the system, or immediately prior to posting his first bid for advance items. Buyer database also contains the tracking number of each bid generated by the buyer, and the tracking number of each seller response if applicable.

Seller database maintains data on sellers with fields such as name, contact information, public/private key information, payment preferences, type of advance items put up for auction, and the amount of such items. This information is obtained when the seller first registers with the system or any subsequent time when the registered user logs onto the system to place the items up for auction. In one exemplary example, the lessors of automobile leases would be sellers, banks holding title, mortgage and liens on items would be sellers, automobile, motorcycle, boat and other transport dealers could be registered sellers, etc.

Advance item database maintains data on the advance items placed up for advance auction. Bid database maintains data on the various bids which are being placed or have been placed for advance auction items database. Information such as asking price, limit price, reserve price and current high bid may be contained in the bid database. In one embodiment, the advance item database and bid database may be a single database.

These elements are in communication with the CPU to facilitate the operation of the network server. Some such servers perform primary processing functions and contain at a minimum, a Random Access Memory (RAM), a Read-Only Memory (ROM), and a general controller or processor. In such an embodiment, each of these servers is attached to a communications hub or port that serves as a primary communication link with other servers, client or user computers and other related devices. The communications hub or port may have minimal processing capability itself, serving primarily as a communications router. A variety of communications protocols may be part of the system, including but not limited to: Ethernet, SAP, SAS™, ATP, Bluetooth, and TCP/IP.

As shown in FIG. 1, network sever 20, 30 may includes central processor (CPU), RAM, ROM, operating system, network interface and data storage device. A conventional personal computer or computer workstation with sufficient memory and processing capability may be used as a central controller or server. In one embodiment the central controller operates as a web server, administering the advance auctions. Central controller must be capable of high volume transaction processing, performing a significant number of mathematical calculations in processing transactions, communications and database searches.

As stated, the server includes a processor, such as one or more conventional microprocessors and one or more supplementary co-processors such as math co-processors. The processor is in communication with a communication port through which the processor communicates with other devices such as other servers, user terminals or devices. The communication port may include multiple communication channels for simultaneous communication with, for example, other processors, servers or client terminals. As stated, devices in communication with each other need not be continually transmitting to each other. On the contrary, such devices need only transmit to each other as necessary, may actually refrain from exchanging data most of the time, and may require several steps to be performed to establish a communication link between the devices.

The processor also is in communication with a data storage device. The data storage device may comprise an appropriate combination of magnetic, optical and/or semiconductor memory, and may include, for example, RAM, ROM, an optical disc such as a compact disc and/or a hard disk or drive. The processor and the data storage device each may be, for example, located entirely within a single computer or other computing device; or connected to each other by a communication medium, such as a USB port, serial port cable, a coaxial cable, a Ethernet type cable, a telephone line, a radio frequency transceiver or other similar wireless or wireline medium.

The data storage device may store, for example, (i) a program (e.g., computer program code and/or a computer program product) adapted to direct the processor in accordance with the present invention, and particularly in accordance with the processes described in detail hereinafter with regard to the controller; (ii) a database adapted to store information that may be utilized to store information required by the program. Database includes multiple records, each record including fields specific to the present invention such as buyer and seller identities, transaction histories, condition information, etc.

The program may be stored, for example, in a compressed, an uncompiled and/or an encrypted format, and may include computer program code. The instructions of the program may be read into a main memory of the processor from a computer-readable medium other than the data storage device, such as from a ROM or from a RAM. While execution of sequences of instructions in the program causes the processor to perform the process steps described herein, hard-wired circuitry may be used in place of, or in combination with, software instructions for implementation of the processes of the present invention. Thus, embodiments of the present invention are not limited to any specific combination of hardware and software.

Suitable computer program code may be provided for performing numerous other functions such as identifying sellers, communicating with buyers and completing financial transactions. The computer program code required to implement the above functions (and the other functions described herein) can be developed by a person of ordinary skill in the art, and is not described in detail herein.

The term “computer-readable medium” as used herein refers to any medium that provides or participates in providing instructions to the processor of the computing device (or any other processor of a device described herein) for execution. Such a medium may take many forms, including but not limited to, non-volatile media, volatile media, and transmission media. Non-volatile media include, for example, optical or magnetic disks, such as memory. Volatile media include dynamic random access memory (DRAM), which typically constitutes the main memory. Transmission media include coaxial cables, copper wire and fiber optics, including the wires that comprise a system bus coupled to the processor. Transmission media may carry acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, a carrier wave as described hereinafter, or any other medium from which a computer can read.

Various forms of computer readable media may be involved in carrying one or more sequences of one or more instructions to the processor (or any other processor of a device described herein) for execution. For example, the instructions may initially be borne on a magnetic disk of a remote computer. The remote computer can load the instructions into its dynamic memory and send the instructions over a telephone line using a modem. A modem local to a computing device (or, e.g., a server) can receive the data on the telephone line and use an infrared transmitter to convert the data to a wireless signal. An infrared detector can receive the data carried in the wireless signal and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless carrier waves that carry data streams representing various types of information.

Referring again to FIG. 1, server 20, 30 may include a bid/payment processor which may include one or more conventional microprocessors, supporting the transfer and exchange of payments, charges, or debits, attendant to the method of the apparatus. Bid/payment processor may also be configured as part of the server CPU. Processing of credit card transactions by bid/payment processor may be supported with commercially available software which transmits credit card numbers electronically over the Internet to perform card verification and processing is handled.

Generally, a network interface may be used as the gateway to communicate with buyers and sellers through their respective interface. Conventional internal or external modems may serve as network interface. Network interface supports modems at a range of baud rates, but may combine such inputs into a T1 or T3 line, coaxial, fiber or other similar high data transfer line if more bandwidth is required. In a preferred embodiment, network interface 160 is connectable with the Internet and/or any of the commercial on-line services or network service providers.

In an exemplary embodiment, sellers and buyers communicate with the central server or controller and thus, to each other through devices 60, 70 such as a personal computer, laptop, palmtop, wireless device and other similar device which has the ability to access the Internet, LAN or WAN, the aforementioned being private, public or a combination of both. In an exemplary embodiment, the seller and buyer interfaces are both conventional personal computers having an input device, such as a keyboard, mouse, or conventional voice recognition software package; a display device, such as a video monitor; a processing device such as a CPU; and a network interface such as a modem. These devices interface with central controller 100. In one example, the buyers and sellers both use browser software and log into central controller through their respective Internet service providers and access a web site provided by the central controller. Through the web site, the buyers and sellers may perform tasks such as submitting advance items for auction, place bids for items and check on the status of pending and closed auctions.

In one embodiment of the present invention, communications between buyers and sellers take place via electronic networks, with a central controller or server acting as a web server. Sellers log on to the central controller and submit items for sale at advance auction. One or more buyers log on to the central controller and submit one or more bids for the advanced auction items. Typically, both sellers and buyers will use Internet browser software along with associated connection or Internet Service Provider software to establish a connection to the central controller. In the present invention, the advance auction items are made available to potential buyers by posting them on the web page of central controller. Maintenance is performed by the central controller to administer the auctions, for example, to update bids and close sales for items where bidding has ended.

The auction facility of the present invention may be accessed by a client program such as a browser that runs on a client machine or device and accesses the auction facility via one or more networks such as the Internet. Other examples of networks that a client may utilize to access the auction facility include a wide area network (WAN), a local area network (LAN), a wireless network (e.g., a cellular network), or the Plain Old Telephone Service (POTS) network or combinations thereof.

In the present invention, such aforementioned networks generally provides interconnection utilizing various interconnection architectures including Internet Protocol (IP) based networks such as the Internet, the public switched telephone network (PSTN), ATM networks, signaling networks, wireless networks, satellite networks, fixed wireless networks, DSL networks as well as other systems. Such networks provide versatile intelligent conduits that may carry, for example, communications between the clients and the auction facility.

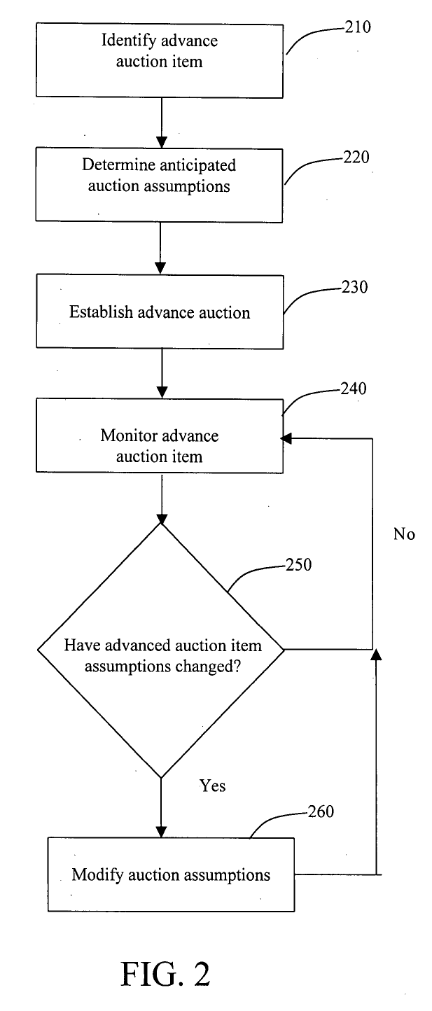

Referring now to FIG. 2 an advance auction method of the present invention is shown. In FIG. 2, an item for advance auction is identified 210. Item identification may be accomplished by using a variety of data study, predictive modeling techniques and data analysis techniques. For example, certain historical data about item buyers and sellers, residual value analysis, demographic data and other such data may be used. It is contemplated that any type of good, services, intangibles, tangibles and other transferable rights and obligations may be auctioned and are referred to interchangeably as auction items herein. For example, in an automobile context, certain data about car buyers or leasers may be used, such as age, driving record, brand reliability, etc to determine candidates for advance auctions. In one more specific example, an advance auction may target certain age individuals in a certain age range such as 40 to 70 years old that lease certain type of cars, like expensive German cars for terms of 2 to 5 years. Based on such information and other empirical information such as the lease expiration date, a pre-emptive auction may be established for such a leased car to start at or around lease inception and end around the time frame of the lease expiration date.

Using profile data based on the lessee's age, predicted mileage, wear and tear on the car, car brand and model, certain auction parameters may be established. For example, if a consumer that fits the profile leases the vehicle in 2007 and has a vehicle turn in date of 2010, then an advance auction is established in 2008, for closing in 2011 with periodic data collection scheduled at one or more interval during the 2008 to 2011 time frame.

Accordingly, the public is greatly benefited since a potential buyer of such a vehicle has ample time to plan their eventual auction purchase, secure funds in advance of the 2011 closing date as well as is offered a much larger selection of potential vehicles to choose from and thus a buyer does not have to settle for whatever cars may be available in a small time period such as a one or two week period such as in the prior art. As used herein, the term auction purchase may be an outright purchase of the item or the winning bidder may also elect to re-lease the car. This can be particularly useful for example, in one particular instance where a consumer is leasing another car themselves which also has a turn in date of around 2011 and that consumer is looking to get another car which is a late model, low mileage vehicle just off of lease after they turn in their own vehicle.

In the present invention it is contemplated that auction items can be identified by studying readily or commonly transferable items that are usually exchanged or transferred, such as car lease, apartment leases, mortgages, contract, etc. or other goods that have a history of multiple owners/possessors such as jewelry and recreational items such as boats, ATVs, motorcycles and jet skis to name a few.

Referring still to FIG. 2, certain anticipated auction assumptions or conditions are determined, step 220. Such assumptions of conditions may be the anticipated close date, the likelihood of closing, the price, the final or expected item condition etc. The advance auction is then established or initiated, step 230. Once initiated, the identified item is open for bidding and periodic monitoring information about the item may be collected/received, step 240. For example, information about the ongoing condition of the item, such as related to wear and tear of the item is received. This information may affect the value of the item and/or a reserve or starting bid price of the item as the item condition varies. It can then be determined if the advance auction item has changed, step 250. For example, if information about the item is received and the information includes data on the item being subject to greater wear and tear than expected at that point in time, certain auction variables may be changed, step 260.

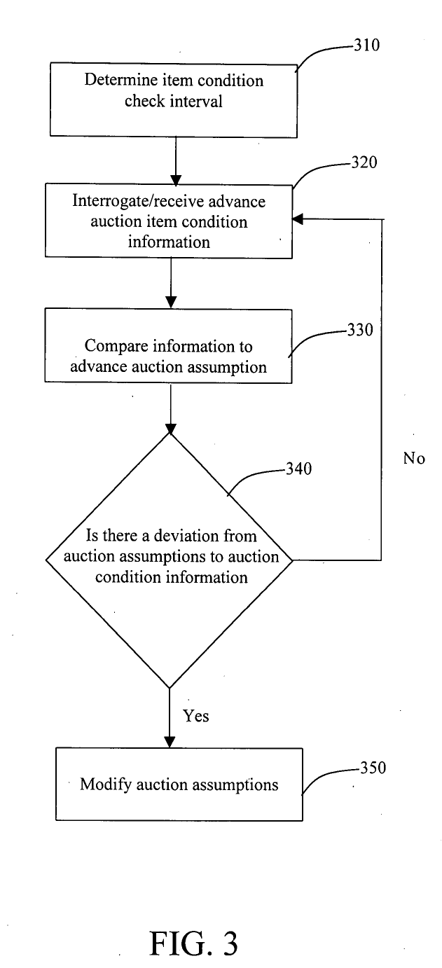

Referring to FIG. 3, in the present invention, a check interval may be determined to check on the item condition, step 310. For example, information about the advance item can be collected once a day, once a month, once a year, twice a quarter or other variations of intervals. In one aspect of the present invention, information about the item to be auctioned may be collected in a variety of manner, such as through automated telematics or sensor type information, e.g. in the case of an automobile to be auctioned, information such as mileage, etc may be captured, information services such as vehicle repair and accident information services may be used to determine if the vehicle is being repair, etc as well as numerous other sources and methodologies for information collection and transmission such as sources of information such as the Department of Motor Vehicles, insurance databases, etc.

For example, in one exemplary instance, where information about a motor vehicle is received indicating that the motor vehicle has been traveling in excess of the anticipated mileage predicted or even information that the vehicle is being driven at higher rates of speed than anticipated, certain advance auction parameters or variables may be modified, such as starting price (if any), reserve price(if any) auction duration, etc. In the case of other items such as antiques or art, information about the storing or displaying of the item may be collected/received such as like the humidity levels, etc of the item's location. These devices may push data to the auction server or such data may be pulled or received, step 320. Once the information is access, the information is compared to the auction assumptions, step 330. It is then determined if there is a deviation or if the deviation is great enough from the assumptions, step 330. If there is cause for modification, then the auction assumptions are changed, step 350. Current bidders on the auction may be notified upon any change in such assumptions due to the changing advance auction item condition.

In determining the close date of the auction, which may be dynamically varied within a specified time frame, a number of factors may be considered. For example, a non-limiting set of factors may be the likelihood that the current owner will be trading in or trading up their current item, the item condition, environmental and economic factors affecting the current owner, and contractual obligations affecting the owner, etc. For example, in one exemplary instance involving the lease of an automobile, a lessee may be contractually obligated to hold the automobile until a certain time frame, such as 24-48 months after inception of the lease. The close date of the advance auction would then be determined based on the contractual time frame, i.e. 36 months post the lease inception. The close date may then be an actual date or a date range, such as 34-38 months post lease inception. A prospective bidder would then at least know with some certainty that 34-38 months post the lease inception date, the vehicle would be available. It is contemplated that if the original owner or seller then keeps the item beyond the date or date range predicted or anticipated, then the auction parameters may be modified, e.g. the auction closing date extended, the starting bid price lowered, and/or the reserve lowered and the potential buyers may be given notice of the extension and/or the opportunity to cancel their bid.

In another exemplary instance, a home owner who is on a corporate re-location or assignment for a certain fixed period of years in a certain home would have a move-out date established with some certainty. From this information, as well as other information, the move out date and hence the availability date of the home would be known and an advance auction with a predicted close date could be established. In another exemplary instance, apartment renters with fixed lease terms could have the availability of this apartment auctioned off in advance auction since the move-out/availability date could be determined with some certainty based on the lease/rental agreement termination date, whether the occupant has a renewal option and even the occupant's prior historical stability information, such as how often that person have moved in the past and their previous historical occupancy information.

In another aspect of the present invention, the advance auction may be established by the seller of the original item to the original owner. For example, if there are certain goods/services that historically or predictively have short possession/ownership time frames, these items could be sold in conjunction with the establishment of an advance auction of the present invention. For example, in the case of motor vehicles or high end motorcycles, data may exist that shows that a certain brand of motorcycle is bought by a certain type of individual and is held for a certain period, e.g. based on historical purchasing/demographic data, said individual is predicted to hold the motorcycle for a period of 36 months before putting the item up for sale or trading the item in. In these instances, the advance auction of the item can coincide with the initial sale of the item to the original seller. Thus, an original seller would close a transaction for sale (lease or otherwise) to a first buyer and then immediately or shortly thereafter initiate an advance auction on the item just sold (leased or otherwise) for purchase by a second buyer. In this manner, a second buyer can begin planning for potential acquisition of the manner for a period of at least 36 or less months in advance.

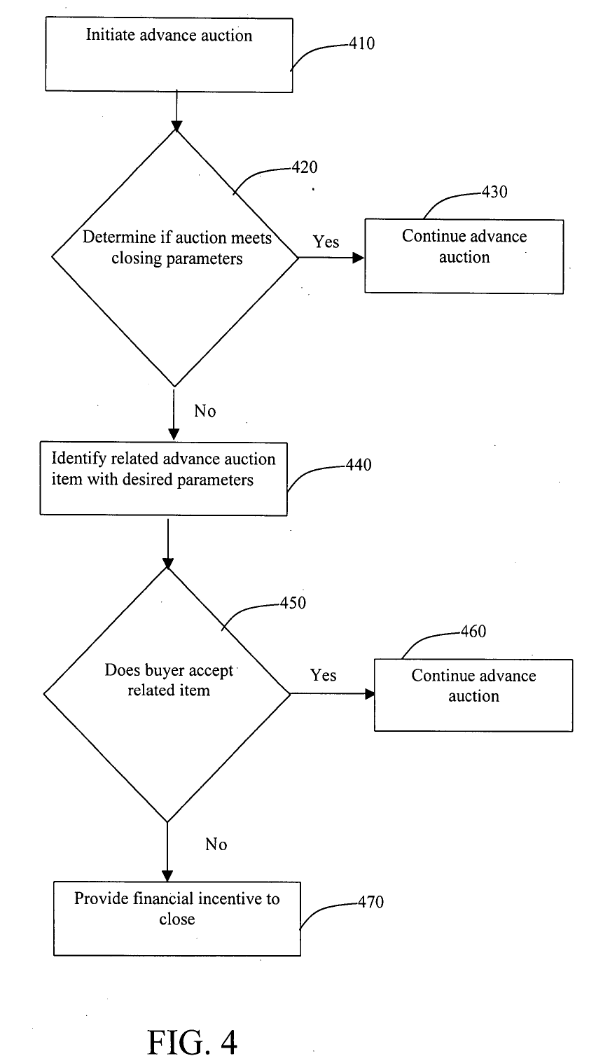

Referring to FIG. 4, an advance auction is initiated, 410. Upon closing, it is determined if the auction meets certain closing parameters, step 420, and if so, then the advance auction is continued to completion, step 430. If not, then it is contemplated that one or more items fitting the initial advance auction profile may be selected so that if the initially selected advance auction item does not become available according to predictions, then another can be readily substituted in place, with or without disclosure to the eventual buyer, step 440 For example, the substitution process may be transparent to the buyer such as the buyer is never notified of the actual Vehicle Identification Number of the potential item, but is only given more general information such as make, year, model, condition, color, etc. In other instances, the buyer may be given specific information and given the option to close on an alternative item, step 450. If accepted, the advance auction is continued to completion, step 460. In other examples, sellers may be given financial incentives to keep their items within certain condition parameters such as by closing on certain dates or certain item condition parameters such as wear and tear and etc., step 470. For example, in a vehicle context, certain incentives may be provided where a vehicle operator may be given incentives for driving less miles than planned or contracted for. Additional, such information may be provided to the advance auction system whereby certain auction parameters such as the starting bid price of the item or the reserve price of an item are raised based on better than expected or predicted item condition. In other examples, buyers may be given financial incentives in instance, e.g. where they may be given the option to purchase substitution items.

In another exemplary application of the present invention, an advance auction for real estate may be begun by a mortgage lender based on real estate for which the mortgage lender has provided a sub-prime loan for. For example, based on the likelihood of default of the loan by the borrower, an advance auction could be established based, for example, on the likelihood that the borrower will default on the loan within a certain number of years. For example, if the lender provides a thirty year loan with an adjustable interest rate which will likely go up substantially in a certain number of years, e.g. five years, the advance auction could be established to start at the inception of the loan and near or after the interest adjustment since there is high likelihood that the borrower will default on the loan when the interest rates go substantially up thereby rendering the borrower's monthly payments difficult to meet at that point in time. Thus an advance auction during years 1-5 of the loan would be conducted with an anticipated closing date at the time of default of the loan, foreclosure by the buyer and subsequent sale to the new third party buyer of the real estate.

In the present invention, the advance auction process may repeat itself for each successive seller/buyer of an item. For example, if the advance auction buyer is also likely to transfer or sell the same item within a predeterminable time period, that item may again be placed in advance auction, and such a process may continue for several or theoretically an unlimited amount of times subject to the condition and availability of the item.

In the present invention, the advance auctions may place no obligation of buyers/bidders during an initial term of the advance auction up until actual close of the auction, where, for example, payment and transfer/sale of the item to be auctioned would be obligated. In one scenario, original sellers would not know of the advance auction and in other they both may have knowledge and in other instances, may even consent to the advance auction. In one instance the original owner may sign an agreement to transfer the item upon their relinquishment of it subject to their own timing, contractual obligations and other conditions for releasing the item. In another exemplary instance, an original owner may knowingly contract with the advance auction provide to deliver the advance auction item to the auction provider upon close of the advance auction. Financial incentives may be provided to original owner such as a percentage of the advance auction price or some fixed fee.

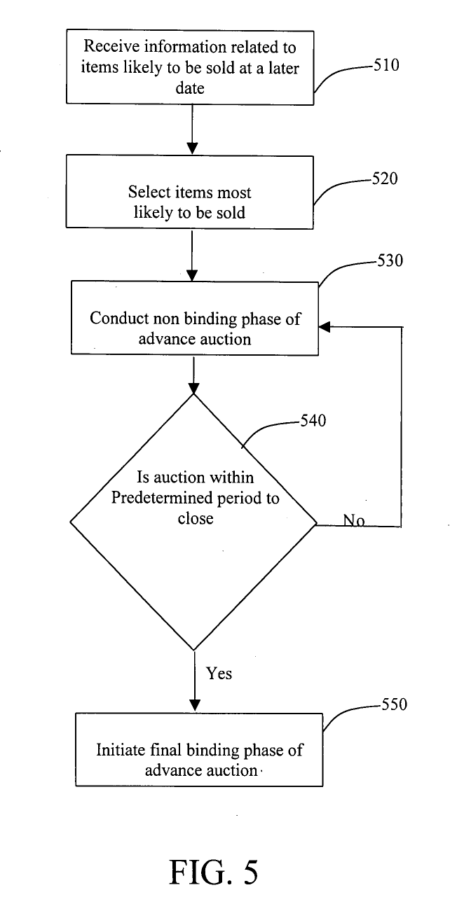

Referring to FIG. 5, in another example, information related to advance auction items is received, step 510. The items most likely to close or with the highest probability to close are selected for advance auction, step 520. These advance auctions may be conducted in multiple phases such as in a no-obligation mode where the initial part of the auction would be conducted with no obligation on the part of, for example, bidders who are bidding on the item, step 530. Advance auctions may then convert to an obligation phase, where bidders are obligated to follow through on any bids made during the obligation phase. For example, in the instance of an advance auction for a leased vehicle being leased for 36 months, the auction would be conducted in a no-obligation phase during the first 30 months of the auction and then in an obligation phase during the last 6 months of the auction or where it is determined that the auction is within a certain predetermined threshold for closing, step 540 It is contemplated that auctions may be fully conducted solely in an obligation phase, where any bid obligates the bidder during the entire term of the auction, step 550.

In another example of the present invention, advance auction items may be combined such that one or more advance auction items may be combined into a singular or package auction, such as an auction for a house and a car which may have anticipated closing at similar times or in another example, an advance auction for an apartment lease and a television for a new tenant.

In the present invention, bids for the advance auction may be received from any bidder, provided the bidder has completed any necessary registration/initiation information for the auction site/service. In another embodiment, as described below, bids may be restricted to bidders with an established or verified history/profile/feedback. For example, the site/service may only accept bids from bidders that have already conducted successful auctions in the past.

In the present invention, charges may be levied or charged for advance auction. In one embodiment, an on-line auction service or site may charge a listing entity/person for conducting the advance auction. In one embodiment, the charge for the advance auction may be refunded or credited provided the item actually sells. Commissions may also be charged for such advanced auctions.

Furthermore, while the present invention has been described with reference to a number of exemplary embodiments, it will be understood by those of ordinary skill in the art that various changes may be made and equivalents may be substituted for elements and steps thereof without departing from the scope of the invention. In addition, many modifications may be made to adapt a particular device, situation, component or step to the teachings of the invention without departing from the scope thereof. Therefore, it is intended that the invention not be limited to the particular embodiment disclosed, but that the invention will include all embodiments falling within the scope of the appended claims.

I claim:

1. A system for conducting an advance on-line auction for items not yet for sale that are likely to become available at a certain date, the system comprising:
at least one server for:
identifying one or more items for advance auction based on a variety of advance auction item parameters;
establishing a predicted auction date for auction close;
listing the item for the advance auction;
periodically receiving information related to an advance auction item;
modifying in the server certain advance auction conditions in response to the received information; and
providing a display of an advance auction open for bidding, wherein one or more of the auction item conditions may vary based n the received information related to the advance auction item.

2. The system of claim 1, wherein the server is in communication with one or more item sensors for capturing and transmitting information about the advance auction item.

3. The system of claim 1, wherein the server is in communication with a third party information service which provide periodic information about the advance auction item.

4. The system of claim 1, wherein the advance auction has a variable dynamic closing date conditioned on one or more advance auction identification parameters.

5. The system of claim 1, wherein the advance auction item parameters includes a determination of a likelihood that the advance auction item will be transferable.

6. The system of claim 5, wherein the fluctuating anticipated close date is dependent on the variety of advance auction item parameters including one of a contract date, a termination date and a foreclosure date.

7. The system of claim 1, wherein the auction item is a leased item.

8. A computerized method for preemptively auctioning items not yet for sale by an original owner, comprising:
identifying an item not yet for sale by an original owner which has a high likelihood of being sold;
initiating an advance auction to one or more third party buyers proximal to a transfer of the item to the original owner;
modifying the advance auction based on data about the item; and
soliciting bids for the item.

9. The method of claim 8, wherein a first phase of the advance auction is nonbinding.

10. The method of claim 8, further comprising: providing incentives to the original owner to maintain the condition of the item.

11. The method of claim 8, further comprising: identifying replacement items which match parameters of original item and offering replacement items to a buyer.

12. The method of claim 11, wherein financial incentive is provided to the third party buyer to purchase the backup item.

13. The method of claim 8, further comprising establishing an agreement with the original buyer to transfer the item to the third party buyer.

14. The method of claim 8, further comprising closing the auction with the third party buyer by receiving the item from the original owner.

15. The method of claim 8, wherein the item is identified based on purchasing and re-selling histories of original buyers.

16. A computer implemented system for conducting anticipatory auctions for items still in possession of an original party but anticipated to become available for transfer, comprising:
a selection server for identifying and selecting items not yet for sale which are likely to be exchanged at an definable time;
an auction server for conducting auctions for the items; and
a processor for varying certain auction parameters based on information relating to the item.

17. The system of claim 16, wherein the selection server and the auction server are in communication with one or more external data sources.

18. The system of claim 16, further comprising a payment server for processing payment for the auction item.

19. The system of claim 16 wherein the selection server determines the definable time for permissible exchange of the item by determining at what date the original party possessor of the item is legally obligated to return the item.

20. The system of claim 19, wherein multiple similar items are selected as backup items in case the item is not exchanged at the defined time.
